(19) United States
(12) Patent Application Publication
(10) Pub. No.: US 2020/0385952 A1
(43) Pub. Date: Dec. 10, 2020

(54) AN IMPLEMENT ATTACHMENT DEVICE

(71) Applicant: Volvo Construction Equipment AB, Eskilstuna (SE)

(72) Inventor: Christian Hahn, Schmelz (DE)

(21) Appl. No.: 16/769,435

(22) PCT Filed: Dec. 8, 2017
(86) PCT No.: PCT/EP2017/082058

§ 371 Date: Jun. 3, 2020

(51) Int. Cl. E02F 3/36; E02F 9/22; F15B 11/00

(52) U.S. Cl. CPC E02F 3/3663; E02F 3/3636; E02F 9/2221; E02F 9/2271; E02F 3/283; E02F 9/2289; E02F 9/2275; F15B 11/003; E02F 9/2267

(57) ABSTRACT

An implement attachment device, for selectively attaching an implement to a working machine includes
a hydraulic cylinder including a cylinder housing with first and second longitudinal ends, a piston in the cylinder housing, and a piston rod fixed to the piston and protruding through the first end of the cylinder housing,
an attachment element being connected to a protruding portion of the piston rod, and adapted to engage with a complementary element of the implement, and
a hydraulic conduit and valve arrangement connected to the hydraulic cylinder,
wherein the conduit and valve arrangement is arranged to selectively allow a communication between a piston side chamber of the hydraulic cylinder and a rod side chamber of the hydraulic cylinder.

### TECHNICAL FIELD

The invention relates to an implement attachment device, and a working machine.

The invention is applicable to working machines within the fields of industrial construction machines or construction equipment, for example wheel loaders. Although the invention will be described with respect to a wheel loader, the invention is not restricted to this particular machine, but may also be used in other working machines, such as excavators and backhoe loaders.

### BACKGROUND

A working machine, such as a wheel loader, is usually provided with a bucket, container, gripper, or other type of implement for digging, carrying and/or transporting a load. For example, a wheel loader has a lift arm unit for raising and lowering the implement. Usually a hydraulic cylinder or a pair of hydraulic cylinders are arranged for raising the lift arm and a further hydraulic cylinder is arranged for tilting the implement relative to the lift arm.

In addition, the working machine is often an articulated frame-steered vehicle and has one, or a pair of, hydraulic cylinders for turning or steering the working machine by pivoting a front unit and a rear unit of the working machine, relative to each other. The hydraulic system generally further comprises at least one hydraulic pump, which is arranged to supply hydraulic power, i.e. hydraulic flow and/or hydraulic pressure, to the hydraulic cylinders.

For attaching an implement to a working machine, an attachment bracket might be provided at the lift arm. The attachment bracket may be provided with one or more, often two, implement attachment devices. An attachment device may be hydraulically operated and controllable from a drivers cabin of the working machine. The attachment device may further be arranged to engage a complementary mating device on the implement, so as to engage with the implement. Thus, implement attachment devices allow the operator to exchange the implement in a comfortable way from an operator seat.

Once the implement is attached to the working machine, it is important for safety reasons that the implement is securely locked to the load arm, e.g. to protect the operator or people in the vicinity of the working machine. US2009095365 describes a hydraulic implement attachment system in which, when an implement is applied to a working machine, a 6/2-way valve is controlled so as to pressurize a line to a piston side of a hydraulic cylinder, urging piston rods of the cylinder outwards to a locking position. A check valve ensures that the pressure in the line will be sustained, thereby providing a locking effect, in the event of a hose rupture or a hose malfunction. The check valve is controlled by a pilot line from a line from the 6/2-way valve to a piston rod side of the hydraulic cylinder. A 6/2-way valve would normally be designed as a spool type valve, and such valves are known for tendencies to leak. A small leakage past the 6/2-way valve to the piston rod side line could cause a pressure build-up in the pilot line. This pressure build-up could keep the check valve open, whereupon the hydraulic cylinder could start to creep.

### SUMMARY

An object of the invention is to increase safety, related to working machine implement attachment devices.

The object is achieved by an implement attachment device according to claim 1. Thus, the invention provides an implement attachment device, for attaching an implement to a working machine, comprising
a hydraulic cylinder with a cylinder housing with first and second longitudinal ends, a piston in the cylinder housing, and a piston rod fixed to the piston and protruding through the first end of the cylinder housing,
an attachment element being connected to a free end of a protruding portion of the piston rod, and adapted to engage with a complementary element on the implement,
a hydraulic conduit and valve arrangement connected to the hydraulic cylinder,
wherein the conduit and valve arrangement is arranged to selectively allow the communication between a piston side chamber of the hydraulic cylinder and a rod side chamber of the hydraulic cylinder.

The communication between the piston side chamber and the rod side chamber of the hydraulic cylinder provides for securing the attachment of the implement to the working machine in a particularly robust and safe manner. More specifically, the communication between the piston side chamber and the rod side chamber will prevent the piston from moving. The reason is that an incremental piston movement will, due to the presence of the piston rod, create an unequal volume change on opposite sides of the piston. This volume change inequality willm at least where the conduit and valve arrangement blocks a communication between the hydraulic cylinder and a hydraulic fluid storing and pumping arrangement, prevent hydraulic fluid from moving from one side of the piston to the other side of the piston, via the communication between the piston side chamber and the rod side chamber. Where a communication between the hydraulic cylinder and a hydraulic fluid storing and pumping arrangement is allowed, the communication between the piston side chamber and the rod side chamber will create equal pressures on either side of the piston. Since the exposed surface area of the piston is larger in the piston side chamber than in the rod side chamber, due to the presence of the piston rod, the communication between the piston side chamber and the rod side chamber will result in the piston moving to expand the hydraulic cylinder. Thereby, it may be secured that the attachment element is kept engaged with the complementary element on the implement, so that the implement is kept attached.

In addition, the communication between the piston side chamber and the rod side chamber will secure that the pressure is always equal on both sides of the piston. This means that even if the pressure in the conduit and valve arrangement falls, e.g. due to a leak, the piston will remain in its position. Embodiments of the invention also provide for an advantageous hydraulic fluid refreshment method, described below.

It should be noted that the invention may be embodied in a large variety of ways. In some embodiments, the implement attachment device forms a part of an attachment device, which is mounted to a lift arm of a working machine. Thereby, the cylinder housing may form a part of the attachment bracket.

Preferably, the conduit and valve arrangement comprises
a control valve,
a conduit arrangement, arranged to provide a communication between the hydraulic cylinder and the control valve, and
a locking valve arranged to allow, in a first position, the communication between the hydraulic cylinder and the control valve by means of the conduit arrangement, and to allow, in a second position, the communication between the piston side chamber and the rod side chamber of the hydraulic cylinder by means of the conduit arrangement.

Thereby, the invention is embodied in a simple and reliable manner. The locking valve could be implemented as a simple 3/2 or 4/2-way valve, as exemplified below. In general, the locking valve could be implemented as any suitable type of valve. Depending on the embodiment of the invention, the locking valve may be provided with an actuation device, which is arranged to operate in a variety of ways. For example, the locking valve may be arranged to be actuated electrically, with a hydraulic pilot pressure, with an air pilot pressure, mechanically, or even manually. In some embodiments, the locking valve may be provided with an actuation device, which forces the locking valve to assume one of the first and second positions, when not energized, and to assume the other of the first and second positions when energized. Advantageously, the locking valve is actuated electro-hydraulically. This provides a solution with a low degree of complexity and a low cost.

It is understood that the control valve may be arranged to communicate with a hydraulic fluid storing and pumping arrangement.

Preferably, the conduit arrangement comprises a piston side conduit extending from the control valve to a piston side of the hydraulic cylinder, and a rod side conduit extending from the control valve to a rod side of the hydraulic cylinder. Preferably, the locking valve is arranged to allow, in the first position, the communication between the hydraulic cylinder and the control valve, through the piston side conduit as well as through the rod side conduit, and to allow, in the second position, the communication between the piston side chamber and the rod side chamber, via at least a portion of the piston side conduit and at least a portion of the rod side conduit. Thereby, it is secured that the conduit and valve arrangement is arranged to selectively allow, on one hand, a communication between the hydraulic cylinder and the control valve so as to allow control of the hydraulic cylinder by means of the control valve, and on the other hand, the communication between a piston side chamber and a rod side chamber of the hydraulic cylinder.

In some embodiments, the locking valve is bypassed by a first of the piston side conduit and the rod side conduit, and arranged to assume a first position in which communication through all of a second of the piston side conduit and the rod side conduit is allowed, and to assume a second position in which a communication between a portion of the second conduit, extending between the locking valve and the hydraulic cylinder, and the first conduit is allowed, while communication through all of the second conduit is blocked. Thereby, the first conduit may be unaffected by the locking valve, and the locking valve may be embodied as a simple 3/2-way valve, as exemplified below.

In embodiments of the invention, the locking valve comprises a piston side chamber port and a rod side chamber port, connected to the piston side chamber and the rod side chamber, respectively, the locking valve being arranged to short cut the piston side chamber port and the rod side chamber port. Thereby, a simple and reliable way of providing the communication between the piston side chamber and the rod side chamber of the hydraulic cylinder is provided.

An aspect of the invention provides an implement attachment device, for attaching an implement to a working machine, comprising
a hydraulic cylinder with a cylinder housing with first and second longitudinal ends, a piston in the cylinder housing, and a piston rod fixed to the piston and protruding through the first end of the cylinder housing,
an attachment element being connected to a free end of a protruding portion of the piston rod, and adapted to engage with a complementary element on the implement,
a control valve,
a piston side conduit extending from the control valve to a piston side chamber of the hydraulic cylinder, and a rod side conduit extending from the control valve to a rod side chamber of the hydraulic cylinder,
and a locking valve arranged to selectively allow and block communication through the rod side conduit, the piston side conduit bypassing the locking valve,
wherein a bypass conduit connects portions of the rod side conduit on opposite sides of the locking valve while bypassing the locking valve, a one way valve being arranged to block a flow of hydraulic fluid in a direction from the control valve towards the rod side chamber, and to allow a flow in the opposite direction above a threshold pressure difference.

As explained below, the one way valve being arranged to allow a flow in the bypass conduit in the direction from the rod side chambers towards the control valve, above the threshold pressure difference, allows for the attachment device to become engaged with an implement, while the locking valve is set to block the rod side conduit. This reduces the number of operational steps at the implement engagement.

The object is also reached with a working machine with an implement attachment device according to any embodiment described or claimed herein.

The invention also provides a method for refreshing fluid in a hydraulic cylinder, comprising a cylinder housing with first and second longitudinal ends, a piston in the cylinder housing, and a piston rod fixed to the piston and protruding through the first end of the cylinder housing, a hydraulic conduit and valve arrangement connecting the hydraulic cylinder with a hydraulic pump, the method comprising setting the conduit and valve arrangement in a first setting, in which a communication is provided between a piston side chamber and a rod side chamber of the hydraulic cylinder, and between the piston side chamber and a hydraulic pump, and subsequently setting the conduit and valve arrangement in a second setting in which a communication is provided between the rod side chamber and the hydraulic pump, and between the piston side chamber and a hydraulic fluid storage container.

It is understood that the hydraulic pump is preferably arranged to pump hydraulic fluid, e.g. hydraulic oil, from the hydraulic fluid storage container to the hydraulic conduit and valve arrangement. The hydraulic fluid storage container is preferably arranged to receive hydraulic fluid from the hydraulic conduit and valve arrangement. The hydraulic cylinder, the hydraulic conduit and valve arrangement, the hydraulic fluid storage container, and the hydraulic pump may form parts of a hydraulic circuit.

In the first setting, a hydraulic fluid return communication, from the piston side chamber and the rod side chamber to the hydraulic fluid storage container, is preferably blocked. In the second setting, the communication between a piston side chamber and a rod side chamber is preferably blocked.

The steps of setting the conduit and valve arrangement in a first setting, and setting the conduit and valve arrangement in a second setting, are preferably repeated, one after the other, a plurality of times. The hydraulic cylinder may form a part of an implement attachment device according to any embodiment described or claimed herein.

During each cycle of the fluid refreshing method, some fluid will be transported from the pump towards the hydraulic cylinder, and from the hydraulic cylinder towards the hydraulic tank. Thereby, the method provides for replacing the fluid in the hydraulic cylinder with filtered fluid. This allows for securing that filtered and fresh fluid is present in the hydraulic cylinder. Thereby, the functionality of the hydraulic cylinder may be secured. Thereby, safety related to implement attachment devices for working machines may be increased.

Further advantages and advantageous features of the invention are disclosed in the following description and in the dependent claims.

### BRIEF DESCRIPTION OF THE DRAWINGS

With reference to the appended drawings, below follows a more detailed description of embodiments of the invention cited as examples.

In the drawings:

FIG. 1 is a side view of a wheel loader.

FIG. 2 is a diagram of an implement attachment device for the wheel loader in FIG. 1.

FIG. 3 shows the implement attachment device in FIG. 2, with a conduit and valve arrangement in a first position.

FIG. 4 shows the implement attachment device in FIG. 2, with the conduit and valve arrangement in a second position.

FIG. 5 is a block diagram depicting steps in a method according to an embodiment of the invention.

FIG. 6 is a diagram of an implement attachment device according to a further embodiment of the invention.

FIG. 7 is a diagram of an implement attachment device according to another embodiment of the invention.

FIG. 8 is a diagram of an implement attachment device according to yet another embodiment of the invention.

FIG. 9 is a diagram of an implement attachment device according to an additional embodiment of the invention.

FIG. 10 is a diagram of an implement attachment device according to a further embodiment of the invention.

### DETAILED DESCRIPTION OF EXAMPLE EMBODIMENTS OF THE INVENTION

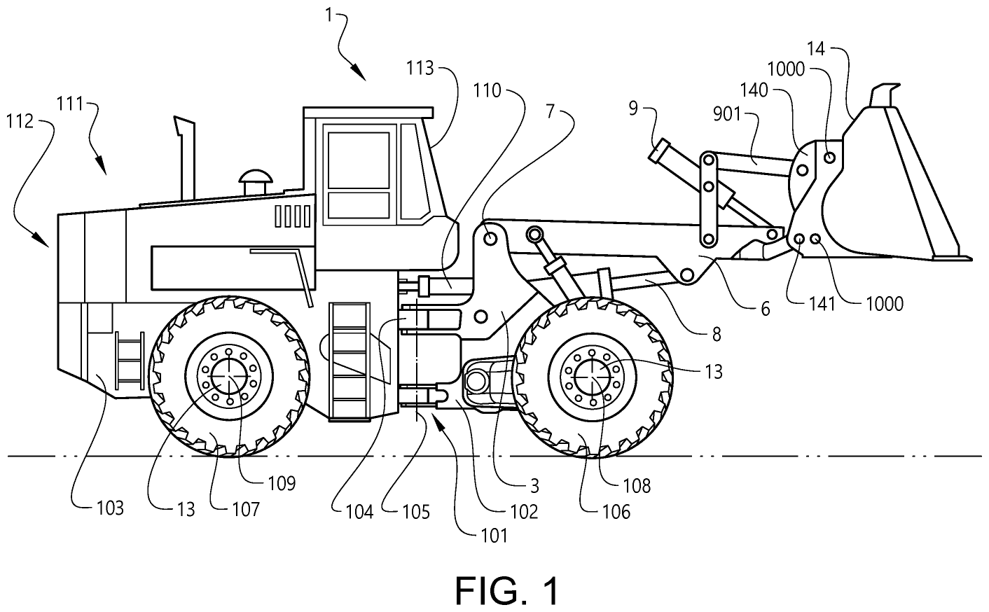

FIG. 1 is an illustration of a working machine 1 in the form of a wheel loader. The wheel loader comprises a body structure 101 with a front unit 102 and a rear unit 103. The front unit 102 comprises a frame 3 described closer below. The front unit 102 and the rear unit 103 are mounted to each other via a pivotable coupling 104. The front unit 102 and the rear unit 103 present two front wheels 106 and two rear wheels 107, respectively. The front wheels 106 define a front wheel axis 108 and the rear wheels 107 define a rear wheel axis 109.

The pivotable coupling 104 is arranged to allow the front and rear units to pivot in relation to each other around a pivot axis 105, which is substantially vertical when the wheel loader 1 is supported on a horizontal surface. Two steering hydraulic cylinders 110 are arranged on opposite sides of the wheel loader 1, for turning the wheel loader by means of relative movement of the front unit 102 and the rear unit 103. In other words, the wheel loader 1 is articulated and frame steered by means of the steering hydraulic cylinders 110.

The rear unit 103 of the wheel loader 1 comprises an engine compartment 111 with an internal combustion engine and a radiator system 112. In some embodiments, the wheel loader 1 may have an electric hybrid propulsion system, or a fully electric propulsion system. The rear unit 103 further comprises a driver compartment 113, herein also referred to as a cab. At each wheel 106, 107, a service brake is provided.

The wheel loader 1 comprises an implement 14. The term “implement” is intended to comprise any kind of tool suitable for a wheel loader, such as a bucket, a fork, or a gripping tool. The implement 14 illustrated in FIG. 1 is a bucket. The implement 14 is arranged on an elongated lift arm 6 for lifting and lowering the implement 14, relative to the body structure 101.

The lift arm 6 is at a first end rotatably or pivotably connected to the frame 3 at a first pivot connection 7. The implement 14 is mounted to the lift arm 6 at a second pivot connection 141, at a second end of the lift arm 6. For this the implement 14 is attached to an attachment bracket 140 as described below. The attachment bracket 140 is in turn pivotally mounted to the lift arm 6 at the second pivot connection 141. The lift arm 6 is arranged to be pivoted around the first pivot connection 7 by means of a main hydraulic cylinder 8 being part of a hydraulic system of the wheel loader. Thereby the lift arm 6 is pivotable between an upper end position and a lower end position.

The wheel loader also comprises a tilting hydraulic cylinder 9 arranged to actuate a tilting movement of the implement 14 in relation to the lift arm 6. The tilting hydraulic cylinder 9 extends from the lift arm 6 to a linkage mechanism 901, which is adapted to transfer movements from the tilting hydraulic cylinder 9 to the implement 14.

Thus, the implement 14 is attached to the lift arm 6 via the attachment bracket 140. The attachment bracket 14 comprises upper and lower implement attachment devices 1000, for selectively attaching the implement to the lift arm 6.

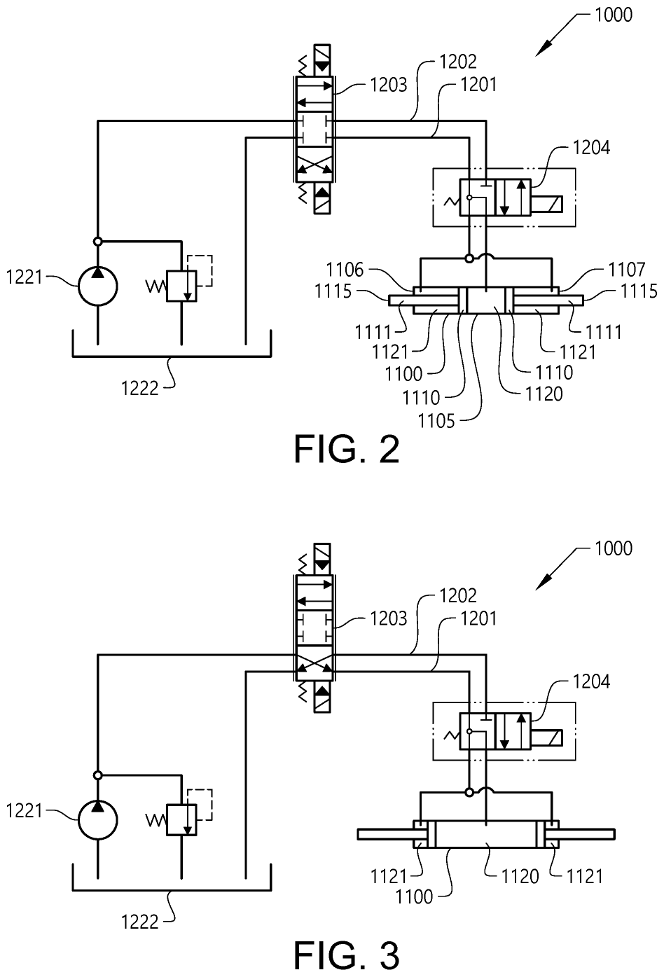

Reference is made also to FIG. 2. Each attachment device 1000 comprises a hydraulic cylinder 1100. The hydraulic cylinder 1100 comprises a cylinder housing 1105 with first and second longitudinal ends 1106, 1107. Two pistons 1110 are provided in the cylinder housing. A respective piston rod 1111 is fixed to each piston. The piston rods 1111 protrude through the first and second ends, respectively, of the cylinder housing.

Each attachment device 1000 comprises two attachment elements 1115 being connected to a protruding portion of a respective of the piston rods. Each attachment element 1115 is, in this embodiment, provided as a pin, adapted to engage with a complementary element of the implement 14. The complementary element may be provided e.g. in the form of an ear with an opening to be protruded by the attachment element 1115.

In this embodiment, each attachment element 1115 is integrated with the respective piston rod 1111. In some embodiments, each attachment element 1115 may be of the same diameter as the respective piston rod 1111. However, in some embodiments, each attachment element 1115 may be a separate piece, which is fixed to the respective piston rod 1111 in some suitable way, e.g. by welding.

Each attachment device 1000 further comprises a hydraulic conduit and valve arrangement 1201-1204 connected to the hydraulic cylinder 1100. The valve arrangement 1201-1204 is hydraulically connected to a hydraulic fluid storing and pumping arrangement of the hydraulic system. The hydraulic fluid storing and pumping arrangement comprises a hydraulic pump 1221 and a hydraulic tank 1222, herein also referred to as a hydraulic fluid storage container. The hydraulic fluid storing and pumping arrangement also comprises a filter (not shown) for filtering the hydraulic fluid.

The conduit and valve arrangement 1201-1204 comprises a control valve 1203. The conduit and valve arrangement 1201-1204 further comprises a conduit arrangement 1201, 1202 arranged to provide a communication between the hydraulic cylinder 1100 and the control valve 1203. The conduit arrangement 1201, 1202 comprises a piston side conduit 1202 extending from the control valve 1203 to a piston side chamber 1120 of the hydraulic cylinder 1100, via a locking valve 1204. The conduit arrangement 1201, 1202 further comprises a rod side conduit 1201 extending from the control valve 1203 to two rod side chambers 1121 of the hydraulic cylinder 1100, via the locking valve 1204. The locking valve 1204 is a 4/2-way valve.

The locking valve 1204 is arranged to allow, in a first position, the communication between the hydraulic cylinder 1100 and the control valve 1203, through the piston side conduit 1202 as well as through the rod side conduit 1201. Thereby, the locking valve 1204 is arranged to allow, in the first position, the communication between the hydraulic cylinder 1100 and the control valve 1203. Thereby, the hydraulic cylinder 1100 may be controlled by the control valve 1203, e.g. when changing the implement. The control valve can in this example assume three positions, two of which provide actuation of the hydraulic cylinder in opposite directions, and the third of which closes any communication between the hydraulic cylinder and the hydraulic fluid storing and pumping arrangement 1221, 1222. More specifically, in this example, the control valve 1203 is a 4/3-way valve. The control valve may be proportionally controlled, so as to allow a gradual transition between said three positions. By means of the control valve 1203, the hydraulic cylinder 1100 can be controlled to retract the attachment elements 1115 to release the implement 14 (FIG. 1) from the attachment bracket 140. Also, by means of the control valve 1203, the hydraulic cylinder can be controlled to deploy the attachment elements 1115, e.g. to engage another implement.

The locking valve 1204 is arranged to allow, in a second position, shown in FIG. 2, the communication between the piston side chamber 1120 and the rod side chambers 1121, via a portion of the piston side conduit 1202 and a portion of the rod side conduit 1201. Said portions of the piston side conduit 1202 and the rod side conduit 1201 extend from the hydraulic cylinder 1100 to the locking valve 1204. Thereby, the locking valve 1204 is arranged to allow, in the second position, the communication between the piston side chamber 1120 and the rod side chambers 1121 of the hydraulic cylinder 1100.

Thus, the conduit and valve arrangement 1201-1204 is arranged to selectively allow, by control of the locking valve 1204, the communication between the piston side chamber 1120 and the rod side chambers 1121. This communication between the piston side chamber 1120 and the rod side chambers 1121, provides for securing the attachment of the implement 14 (FIG. 1) to the attachment bracket 140.

More specifically, as explained above, the communication between the piston side chamber 1120 and the rod side chambers 1121 will prevent the pistons 1110 from moving.

In the second position of the locking valve 1204, the pistons will be prevented from moving, even if the pressure in the conduit and valve arrangement 1201-1204 falls, e.g. due to a conduit rupture, a leakage in the control valve 1203, or even a leakage in the locking valve 1204.

With reference to FIG. 3-FIG. 5, a method for refreshing the fluid, e.g. hydraulic oil, in a hydraulic cylinder 1100, will be described. This allows fluid in the hydraulic cylinder to be replaced, so that it may be secured that filtered and fresh fluid is present in the hydraulic cylinder. Thus, in addition to securing the attachment of the implement to the attachment bracket, the attachment device allows for the refreshment of hydraulic fluid in the hydraulic cylinder. The fluid refreshment method is advantageously executed when there is no implement attached to the attachment bracket.

The method comprises setting S1 the conduit and valve arrangement 1201-1204 in a first setting in which a communication is provided between the piston side chamber 1120 and the rod side chambers 1121, and between the piston side chamber 1120 and the hydraulic pump 1221. More specifically, as shown in FIG. 3, in the first setting, the control valve 1203 is in a position allowing a communication between the pump 1221 and the rod side chamber 1121. Further, in the first setting, the locking valve 1204 is in the second position, in which it allows the communication between the piston side chamber 1120 and the rod side chambers 1121. Thereby, the pistons will be urged so as for the hydraulic cylinder to be extended. The pistons will move away from each other. This is due to the unequal exposure of the pistons to the chambers 1120, 1121. During this extension of the hydraulic cylinder, fluid will move from the rod side chambers 1121 towards the piston side chamber 1120. Also, due to the unequal change of volumes of the chambers 1120, 1121, fluid will be moved from the pump 1221 towards the piston side chamber.

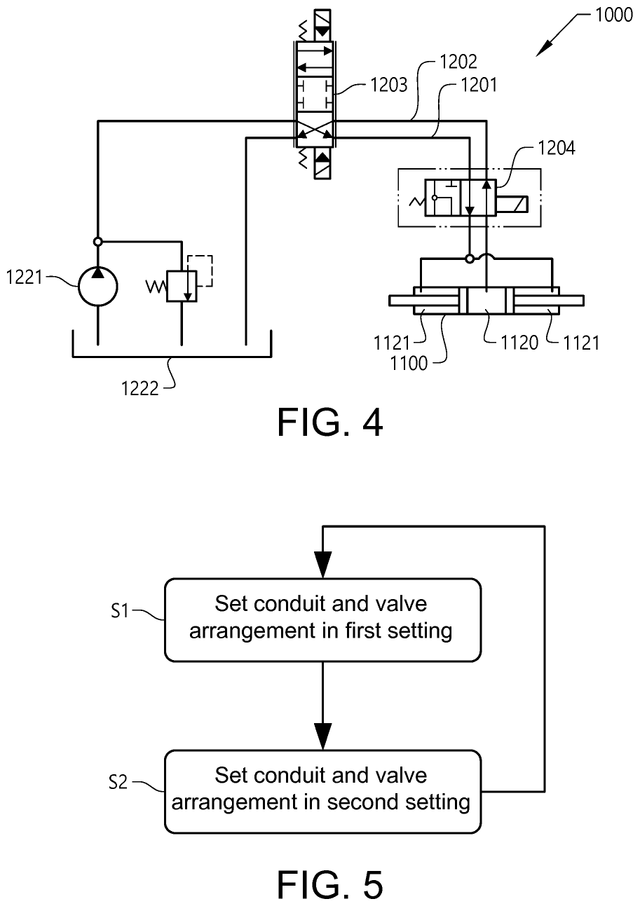

Subsequently, the conduit and valve arrangement 1201-1204 is moved S2 to a second setting in which a communication is provided between the rod side chamber 1121 and the hydraulic pump 1221, and between the piston side chamber 1120 and a hydraulic tank 1222. As shown in FIG. 4, in the second setting the control valve 1203 remains in the position in which it allows the communication between the pump 1221 and the rod side chamber 1121. However, in the second setting, the locking valve 1204 is in the first position, in which it allows the communication between the hydraulic cylinder 1100 and the control valve 1203 through the piston side conduit 1202 as well as through the rod side conduit 1201. Thereby, the pistons will be urged so as for the hydraulic cylinder to be retracted. The pistons will move towards each other. During this retraction of the hydraulic cylinder, fluid will move from the piston side chamber 1120 towards the hydraulic tank 1222.

During the hydraulic fluid refreshment method, the steps S1, S2 of setting the conduit and valve arrangement 1201-1204 in the first setting, and setting the conduit and valve arrangement 1201-1204 in the second setting, are repeated, one after the other, a plurality of times. During each cycle of the method, some fluid will be transported from the pump 1221 towards the hydraulic cylinder, and from the hydraulic cylinder towards the hydraulic tank. Thereby, the method provides for replacing the fluid in the hydraulic cylinder with filtered fluid.

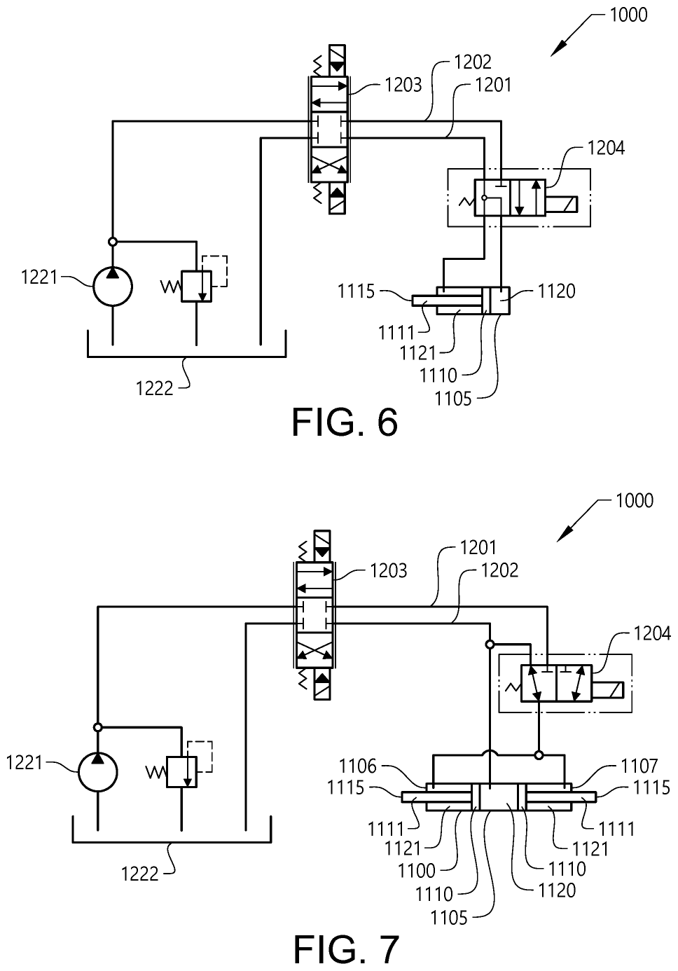

Reference is made to FIG. 6. It should be noted that the invention is equally applicable to an implement attachment device with a hydraulic cylinder comprising only one piston, as in the example in FIG. 6.

Reference is made to FIG. 7, showing an embodiment, which is similar to the one described with reference to FIG. 2, with the following exception: The locking valve 1204 is a 3/2-way valve. The locking valve 1204 is bypassed by the piston side conduit 1202. The locking valve 1204 is arranged to allow, in the first position, a communication through all of the rod side conduit 1201. The locking valve 1204 is arranged to allow, in the second position, a communication between the piston side conduit 1202 and a portion of the rod side conduit 1201, which portion extends between the locking valve 1204 and the hydraulic cylinder 1100, while blocking the communication through all of the rod side conduit 1201. Similarly to the embodiment in FIG. 2, thereby, the locking valve 1204 is arranged to allow, in the second position, the communication between the piston side chamber 1120 and the rod side chambers 1121 of the hydraulic cylinder 1100, thereby securing the attachment of the implement 14 (FIG. 1) to the attachment bracket 140.

Alternatively, the locking valve 1204 may be bypassed by the rod side conduit 1201. Thereby, the locking valve 1204 may be arranged to allow, in the first position, a communication through all of the piston side conduit 1202. The locking valve 1204 may further be arranged to allow, in the second position, a communication between the rod side conduit 1201 and a portion of the piston side conduit 1202, which portion extends between the locking valve 1204 and the hydraulic cylinder 1100, while blocking the communication through all of the piston side conduit 1202.

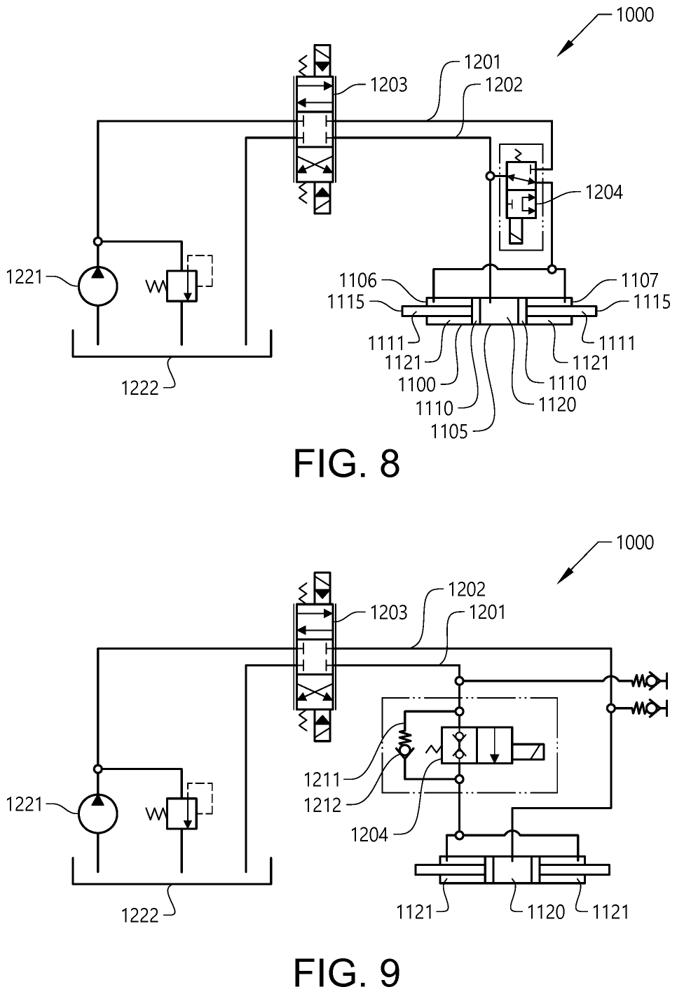

FIG. 8 shows an embodiment, which is similar to the one described with reference to FIG. 7, but where the locking valve 1204 is of an alternative type of 3/2-way valve.

It should be noted that the hydraulic fluid refreshment method described with reference to FIG. 3-FIG. 5, may advantageously be executed on any of the embodiments in FIG. 6-FIG. 8.

Reference is made to FIG. 9, showing an embodiment, which is similar to the one described with reference to FIG. 2, with the following exception: The locking valve 1204 is a 2/2-way valve. The locking valve 1204 is arranged to selectively allow and block a communication through the rod side conduit 1201. The piston side conduit 1202 bypasses the locking valve 1204. A bypass conduit 1211 connects portions of the rod side conduit 1201 on opposite sides of the locking valve 1204 while bypassing the locking valve 1204. A one way valve 1212 is arranged to block a flow of hydraulic fluid in the bypass conduit 1211, in a direction from the control valve 1203 towards the rod side chambers 1121. The one way valve 1212 is further arranged to allow a flow in the bypass conduit 1211, in the opposite direction above a threshold pressure difference across the one way valve 1212.

The locking valve prevents, at a pressure loss in the piston side conduit 1202, the pistons from moving towards each other. The reason is that if the pistons would move towards each other, at a pressure loss in the piston side conduit, the pressure on the rod side chambers 1121 would be below atmospheric pressure. The one way valve 1212 being arranged to allow a flow in the bypass conduit 1211 in the direction from the rod side chambers 1121 towards the control valve 1203, above the threshold pressure difference, allows for the attachment device 1000 to become engaged with the implement 14 (FIG. 1), while the locking valve 1204 is set to block the rod side conduit 1201. This reduces the number of operational steps at the implement engagement.

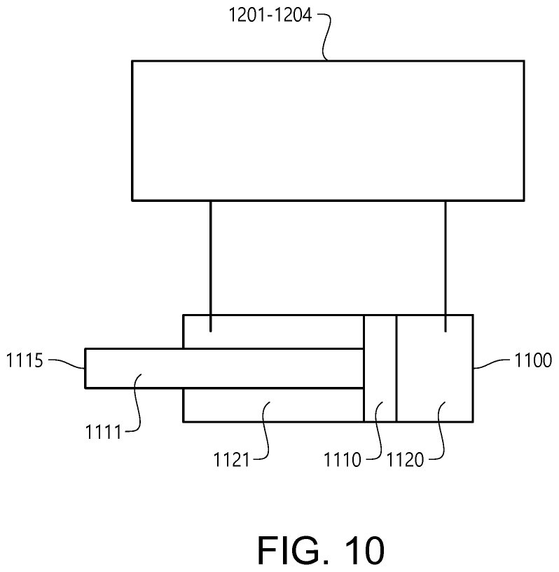

Reference is made to FIG. 10. showing an implement attachment device, according to a further embodiment of the invention. The implement attachment device comprises a hydraulic cylinder 1100 comprising a cylinder housing with first and second longitudinal ends, a piston 1110 in the cylinder housing, and a piston rod 1111 fixed to the piston and protruding through the first end of the cylinder housing. The implement attachment device further comprises an attachment element 1115 being connected to a protruding portion of the piston rod, and adapted to engage with a complementary element of the implement. The implement attachment device also comprises a hydraulic conduit and valve arrangement 1201-1204, connected to the hydraulic cylinder 1100. The conduit and valve arrangement 1201-1204 is arranged to selectively allow a communication between a piston side chamber 1120 of the hydraulic cylinder 1100 and a rod side chamber 1121 of the hydraulic cylinder 1100.

It is to be understood that the present invention is not limited to the embodiments described above and illustrated in the drawings; rather, the skilled person will recognize that many changes and modifications may be made within the scope of the appended claims.

1. An implement attachment device, for selectively attaching an implement to a working machine, comprising
a hydraulic cylinder comprising a cylinder housing with first and second longitudinal ends, a piston in the cylinder housing, and a piston rod fixed to the piston and protruding through the first end of the cylinder housing,
an attachment element being connected to a protruding portion of the piston rod, and adapted to engage with a complementary element of the implement, and
a hydraulic conduit and valve arrangement, connected to the hydraulic cylinder,
wherein the conduit and valve arrangement is arranged to selectively allow a communication between a piston side chamber of the hydraulic cylinder and a rod side chamber of the hydraulic cylinder.

2. An implement attachment device according to claim 1, wherein the conduit and valve arrangement comprises
a control valve,
a conduit arrangement, arranged to provide a communication between the hydraulic cylinder and the control valve, and
a locking valve arranged to allow, in a first position, the communication between the hydraulic cylinder and the control valve by means of the conduit arrangement, and to allow, in a second position, the communication between the piston side chamber and the rod side chamber of the hydraulic cylinder by means of the conduit arrangement.

3. An implement attachment device according to claim 2, wherein the conduit arrangement comprises a piston side conduit extending from the control valve to the piston side chamber of the hydraulic cylinder, and a rod side conduit extending from the control valve to the rod side chamber of the hydraulic cylinder.

4. An implement attachment device according to claim 3, wherein the locking valve is arranged to allow, in the first position, the communication between the hydraulic cylinder and the control valve through the piston side conduit as well as through the rod side conduit, and to allow, in the second position, the communication between the piston side chamber and the rod side chamber via at least a portion of the piston side conduit and at least a portion of the rod side conduit.

5. An implement attachment device according to claim 3, wherein the locking valve is bypassed by a first of the piston side conduit and the rod side conduit, and arranged to allow, in the first position, a communication through all of a second of the piston side conduit and the rod side conduit, and to allow, in the second position, a communication between the first conduit and a portion of the second conduit, which portion extends between the locking valve and the hydraulic cylinder, while blocking the communication through all of the second conduit.

6. An implement attachment device according to claim 2, wherein the locking valve comprises a piston side chamber port, and a rod side chamber port, connected to the piston side chamber and the rod side chamber, respectively, the locking valve being arranged to short cut the piston side chamber port and the rod side chamber port.

7. An implement attachment device, for selectively attaching an implement to a working machine, comprising
a hydraulic cylinder comprising a cylinder housing with first and second longitudinal ends, a piston in the cylinder housing, and a piston rod fixed to the piston and protruding through the first end of the cylinder housing,
an attachment element being connected to a protruding portion of the piston rod, and adapted to engage with a complementary element of the implement,
a control valve,
a piston side conduit extending from the control valve to a piston side chamber of the hydraulic cylinder, and a rod side conduit extending from the control valve to a rod side chamber of the hydraulic cylinder,
and a locking valve arranged to selectively allow and block a communication through the rod side conduit, the piston side conduit bypassing the locking valve,
wherein a bypass conduit connects portions of the rod side conduit on opposite sides of the locking valve while bypassing the locking valve, a one way valve being arranged to block a flow of hydraulic fluid in the bypass conduit in a direction from the control valve towards the rod side chamber, and to allow a flow in the bypass conduit in the opposite direction above a threshold pressure difference across the one way valve.

8. A working machine with an implement attachment device according to claim 1.

9. A method for refreshing fluid in a hydraulic cylinder comprising a cylinder housing with first and second longitudinal ends, a piston in the cylinder housing, and a piston rod fixed to the piston and protruding through the first end of the cylinder housing, a hydraulic conduit and valve arrangement connecting the hydraulic cylinder with a hydraulic pump, the method being characterized by setting the conduit and valve arrangement in a first setting, in which a communication is provided between a piston side chamber and a rod side chamber of the hydraulic cylinder, and between the piston side chamber and a hydraulic pump, and subsequently setting the conduit and valve arrangement in a second setting, in which a communication is provided between the rod side chamber and the hydraulic pump, and between the piston side chamber and a hydraulic fluid storage container.

10. A method according to claim 9, wherein the steps of setting the conduit and valve arrangement in a first setting, and setting the conduit and valve arrangement in a second setting, are repeated, one after the other, a plurality of times.

11. A method according to claim 9, wherein the hydraulic cylinder forms a part of an implement attachment device for selectively attaching an implement to a working machine, comprising a hydraulic cylinder comprising a cylinder housing with first and second longitudinal ends, a piston in the cylinder housing, and a piston rod fixed to the piston and protruding through the first end of the cylinder housing, an attachment element being connected to a protruding portion of the piston rod, and adapted to engage with a complementary element of the implement, and a hydraulic conduit and valve arrangement, connected to the hydraulic cylinder, wherein the conduit and valve arrangement is arranged to selectively allow a communication between a piston side chamber of the hydraulic cylinder and a rod side chamber of the hydraulic cylinder.
